(19) United States
(12) Patent Application Publication
(10) Pub. No.: US 2016/0301065 A1
(43) Pub. Date: Oct. 13, 2016

(54) LITHIUM-CONTAINING COMPOSITE OXIDE, ITS PRODUCTION PROCESS, CATHODE ACTIVE MATERIAL, POSITIVE ELECTRODE FOR LITHIUM ION SECONDARY BATTERY, AND LITHIUM ION SECONDARY BATTERY

(71) Applicant: Asahi Glass Company, Limited, Chiyoda-ku (JP)

(72) Inventor: Tomohiro SAKAI, Chiyoda-ku (JP)

(73) Assignee: Asahi Glass Company, Limited, Chiyoda-ku (JP)

(21) Appl. No.: 15/089,941

(22) Filed: Apr. 4, 2016

(30) Foreign Application Priority Data
Apr. 8, 2015 (JP) 2015-079040

(51) Int. Cl. H01M 4/131; H01M 4/52; H01M 4/505; H01M 4/50; H01M 10/0525; H01M 4/525

(52) U.S. Cl. CPC H01M 4/131; H01M 10/0525; H01M 4/525; H01M 4/505; H01M 4/502; H01M 4/523; H01M 2004/028

(57) ABSTRACT

To provide a lithium-containing composite oxide capable of obtaining a lithium ion secondary battery excellent in the discharge capacity and cycle characteristics and its production process, a cathode active material, a positive electrode for a lithium ion secondary battery which contains the lithium-containing composite oxide and a lithium ion secondary battery.

A lithium-containing composite oxide, which is represented by aLi(Li_{1/3}Mn_{2/3})O₂.(1−a)LiNi_{α}Co_{β}Mn_{γ}O₂ (wherein 0<a<1, 0<α<1, 0≦β<1, 0<γ≦0.5, and α+β+γ=1), wherein in its X-ray diffraction pattern, the logarithmic standard deviation of the crystalline size distribution obtained from a peak of (003) plane assigned to a crystal structure with space group R-3m is at most 0.198.

### FIELD OF INVENTION

The present invention relates to a lithium-containing composite oxide, its production process, a cathode active material, a positive electrode for a lithium ion secondary battery, and a lithium ion secondary battery.

### BACKGROUND ART

As a cathode active material contained in a positive electrode of a lithium ion secondary battery, a lithium-containing composite oxide, particularly LiCoO₂, is well known. However, in recent years, for a lithium ion secondary battery for portable electronic instruments or for vehicles, downsizing and weight saving are required, and a further improvement in the discharge capacity of a lithium ion secondary battery per unit mass of the cathode active material (hereinafter sometimes referred to simply as the discharge capacity) is required.

As a cathode active material which may be able to further increase the discharge capacity of a lithium ion secondary battery, a cathode active material having high Li and Mn contents i.e. a so-called lithium rich cathode active material has attracted attention. However, a lithium ion secondary battery using such a lithium rich cathode active material has a problem such that the characteristics to maintain the charge and discharge capacity at the time of repeating a charge and discharge cycle (hereinafter referred to as the cycle characteristics) tend to decrease.

As a lithium rich cathode active material capable of obtaining a lithium secondary battery excellent in the discharge capacity and cycle characteristics, the following one has been proposed.

A cathode active material consisting of a lithium-containing composite oxide having a crystal structure with space group R-3m and a crystal structure with space group C2/m (lithium excess phase), wherein the lithium-containing composite oxide contains Li, either one or both of Ni and Co, and Mn, the ratio of the molar amount of Mn to the total molar amount (X) of Ni, Co and Mn (i.e. Mn/X) is at least 0.55, and in the X-ray diffraction pattern, the ratio of the integrated intensity (I₀₂₀) of a peak of (020) plane assigned to a crystal structure with space group C2/m to the integrated intensity (I₀₀₃) of a peak of (003) plane assigned to a crystal structure with space group R-3m (i.e. I₀₂₀/I₀₀₃) is from 0.02 to 0.5, and it contains B (boron) in an amount of from 0.001 to 3 mass % (Patent Document 1).

It is disclosed that in the cathode active material, B is present at the surface of the cathode active material, whereby contact of the cathode active material and the electrolyte is suppressed, and the cycle characteristics of the lithium ion secondary battery are improved. However, even by the lithium ion secondary battery using such a cathode active material, the cycle characteristics are not yet at a sufficiently satisfactory level.

### PRIOR ART DOCUMENT

### Patent Document

Patent Document 1: JP-A-2011-096650

### SUMMARY OF INVENTION

### Technical Problem

It is an object of the present invention to provide a lithium-containing composite oxide capable of obtaining a lithium ion secondary battery excellent in the discharge capacity and cycle characteristics and its production process; a cathode active material and a positive electrode for a lithium ion secondary battery, capable of obtaining a lithium ion secondary battery excellent in the discharge capacity and cycle characteristics; and a lithium ion secondary battery excellent in the discharge capacity and cycle characteristics.

### Solution to Problem

The present invention provides the following embodiments.

[1] A lithium-containing composite oxide, which is represented by aLi(Li_{1/3}Mn_{2/3})O₂.(1−a)LiNi_{α}Co_{β}Mn_{γ}O₂ (wherein 0<a<1, 0<α<1, 0≦β<1, 0<γ≦0.5, and α+β+γ=1), wherein in its X-ray diffraction pattern, a logarithmic standard deviation of a crystalline size distribution obtained from a peak of (003) plane assigned to a crystal structure with space group R-3m is at most 0.198.
[2] The lithium-containing composite oxide according to [1], wherein in the formula, α>γ.
[3] The lithium-containing composite oxide according to [1] or [2], wherein a ratio of a molar amount of Ni to a total molar amount (X) of Ni, Co and Mn (i.e. Ni/X) is from 0.15 to 0.55, a ratio of a molar amount of Co thereto (i.e. Co/X) is from 0 to 0.09, and the ratio of the molar amount of Mn thereto (i.e. Mn/X) is from 0.45 to 0.8.
[4] The lithium-containing composite oxide according to any one of [1] to [3], wherein in an X-ray diffraction pattern, an integrated intensity ratio (I₀₂₀/I₀₀₃) of an integral intensity (I₀₂₀) of a peak of (020) plane assigned to a crystal structure with space group C2/m to an integral intensity (I₀₀₃) of a peak of (003) plane assigned to a crystal structure with space group R-3m is from 0.02 to 0.3.
[5] A process for producing a lithium-containing composite oxide, which comprises mixing a transition metals-containing compound essentially containing Ni and Mn and optionally containing Co with a lithium compound so that a ratio of the molar amount of Li to a total molar amount (X) of Ni, Co and Mn (i.e. Li/X) is higher by from 2 to 16% than a theoretical composition ratio and firing an obtained mixture at from 980 to 1100° C., to produce a lithium-containing composite oxide represented by aLi(Li_{1/3}Mn_{2/3})O₂.(1−a)LiNi_{α}Co_{β}Mn_{γ}O₂ (wherein 0<a<1, 0<α<1, 0≦β<1, 0<γ≦0.5, and α+β+γ=1).
[6] The process for producing a lithium-containing composite oxide according to [5], wherein the transition metals-containing compound is a hydroxide essentially containing Ni and Mn and optionally containing Co.
[7] The process for producing a lithium-containing composite oxide according to [5] or [6], wherein the lithium compound is lithium carbonate.
[8] A cathode active material comprising the lithium-containing composite oxide as defined in any one of [1] to [4] or a lithium-containing composite oxide obtained by the process for producing a lithium-containing composite oxide as defined in any one of [5] to [7].
[9] A positive electrode for a lithium ion secondary battery, which comprises the cathode active material as defined in [8], an electrically conductive material and a binder.
[10] A lithium ion secondary battery, which comprises the positive electrode for a lithium ion secondary battery as defined in [9], a negative electrode and a non-aqueous electrolyte.

### Advantageous Effects of Invention

By the lithium-containing composite oxide of the present invention, it is possible to obtain a lithium ion secondary battery excellent in the discharge capacity and cycle characteristics.

By the process for producing a lithium-containing composite oxide of the present invention, it is possible to produce a lithium-containing composite oxide capable of obtaining a lithium ion secondary battery excellent in the discharge capacity and cycle characteristics.

By the cathode active material of the present invention, it is possible to obtain a lithium ion secondary battery excellent in the discharge capacity and cycle characteristics.

By the positive electrode for a lithium ion secondary battery of the present invention, it is possible to obtain a lithium ion secondary battery excellent in the discharge capacity and cycle characteristics.

The lithium ion secondary battery of the present invention is excellent in the discharge capacity and cycle characteristics.

### BRIEF DESCRIPTION OF DRAWINGS

FIG. 1 is an enlarged graph showing the peak of (003) plane assigned to a crystal structure with space group R-3m in an X-ray diffraction pattern of the lithium-containing composite oxide.

FIG. 2 is a graph showing a crystalline size distribution obtained from the peak of (003) plane assigned to a crystal structure with space group R-3m in FIG. 1.

FIG. 3 is a graph showing X-ray diffraction patterns of the lithium-containing composite oxides in Ex. 1, 9 and 11.

FIG. 4 is a graph showing a relation between the logarithmic standard deviation of the crystalline size distribution and the cycle retention rate.

### DETAILED DESCRIPTION OF INVENTION

The following definitions of terms are applied to this specification including Claims.

The “crystalline size distribution” is one obtained by analyzing a specific peak of an X-ray diffraction pattern by using crystalline size distribution analysis software CSDA, manufactured by Rigaku Corporation. The explanation of analysis mechanism is described in the user manual of the crystalline size distribution analysis software, manufactured by Rigaku Corporation, and the detail of the analysis mechanism is described in the following reference documents mentioned in the manual.
(1) Takashi Ida, Annual Report of the Ceramic Research Laboratory Nagoya Institute of Technology, Vol. 6, p. 1 (2006).
(2) T. Ida, S. Shimazaki, H. Hibino and H. Toraya, J. Appl. Cryst., 36, 1107 (2003).
(3) T. Ida and K. Kimura, J. Appl. Cryst., 32, 982 (1999).
(4) T. Ida and K. Kimura, J. Appl. Cryst., 32, 634 (1999).
(5) T. Ida, Rev. Sci. Instrum., 69, 2268 (1998).
(6) International Tables for Crystallography Volume C Second Edition, Edited by A. J. C. Wilson and E. Prince, Kluwer Academic Publishers, Netherlands (1999).
(7) X-Rays in Theory Experiment Second Edition, A. H. Compton and S. K. Allison, D. Van. Norstrand Company, New York (1936).

The “logarithmic standard deviation of crystalline size distribution” is a value obtained from the crystalline size distribution (number distribution) by means of the crystalline size distribution analysis software CSDA, manufactured by Rigaku Corporation.

The “theoretical composition ratio” means the ratio of the molar amount of Li to the total molar amount (X) of Ni, Co and Mn (i.e. Li/X) in aLi(Li_{1/3}Mn_{2/3})O₂.(1−a)LiNi_{α}Co_{β}Mn_{γ}O₂, when the valence of oxygen (O) is bivalent, Li is monovalent, Mn of Li (Li_{1/3}Mn_{2/3})O₂ is tetravalent, Ni of LiNi_{α}Co_{β}Mn_{γ}O₂ is bivalent, Co is trivalent, and Mn is tetravalent (in this case, the average valence is trivalent, and α=γ in order to satisfy the electrical neutral condition). Specifically, the theoretical composition ratio can be obtained from the theoretical composition ratio Li/X=y+2z, when Ni/X, Co/X and Mn/X to be charged for producing a hydroxide are x, y, z (x+y+z=1) respectively. In the calculation, when Li/X is higher than the theoretical composition ratio, a becomes large, and α>γ. Then, the valence of Ni in order to satisfy the valence exceeds 2.

The “specific surface area” is a value measured by a BET (Brunauer, Emmet, Teller) method. In the measurement of the specific surface area, nitrogen gas is used as an absorption gas.

The “D₅₀” is a particle size at a point of 50% on an accumulative volume distribution curve which is drawn by obtaining the particle size distribution on the volume basis and taking the whole to be 100%, that is, a volume-based accumulative 50% size.

The “particle size distribution” is obtained from the frequency distribution and accumulative volume distribution curve measured by means of a laser scattering particle size distribution measuring apparatus (for example, a laser diffraction/scattering type particle size distribution measuring apparatus). The measurement is carried out by sufficiently dispersing the powder in an aqueous medium by e.g. ultrasonic treatment.

The “crystallite size” is obtained by the following Scherrer equation from a diffraction angle 2θ (deg) and half-value width B (rad) of a specific peak in an X-ray diffraction pattern.

D_{abc}=(0.9λ)/(B cos θ)

wherein D_{abc} is a crystallite size of (abc) plane, and λ is the wavelength of X-rays.

The expression “Li” means a Li element, not a Li metal simple substance, unless otherwise specified. The same applies to expressions of other elements such as Ni, Co, Mn, etc.

The composition analysis of a lithium-containing composite oxide is carried out by inductively-coupled plasma spectrometry (hereinafter referred to as ICP). Further, the ratio of elements in a lithium-containing composite oxide is a value with respect to the lithium-containing composite oxide before the first charging (also called activation treatment).

### <Lithium-Containing Composite Oxide>

The lithium-containing composite oxide of the present invention (hereinafter referred to as “present composite oxide” is represented by the following formula I:

aLi(Li_{1/3}Mn_{2/3})O₂.(1−α)LiNi_{α}Co_{β}Mn_{γ}O₂ Formula I

In the formula I, α is higher than 0 and less than 1. When α falls within the above range, it is possible to make the discharge capacity and the discharge voltage of the lithium ion secondary battery high. α is preferably from 0.15 to 0.78, more preferably from 0.3 to 0.65.

In the formula I, α is higher than 0 and less than 1. When α falls within the above range, it is possible to make the discharge capacity and the discharge voltage of the lithium iron secondary battery high. α is preferably at least 0.36 and less than 1, more preferably from 0.40 to 0.83.

In the formula I, β is at least 0 and less than 1. When β falls within the above range, it is possible to make the rate characteristics of the lithium ion secondary battery high. β is preferably from 0 to 0.33, more preferably from 0 to 0.1.

In the formula I, γ is higher than 0 and at most 0.5. When γ falls within the above range, it is possible to make the discharge voltage and the discharge capacity of the lithium iron secondary battery high. γ is preferably from 0.25 to 0.5, more preferably from 0.3 to 0.5.

In the formula I, α is preferably higher than γ. When α>γ, a becomes high, and it is possible to make the discharge capacity of the lithium iron secondary battery higher. Further, in the X-ray diffraction pattern, the logarithmic standard deviation of the crystalline size distribution obtained from a peak of (003) plane assigned to a crystal structure with space group R-3m tends to be at most 0.198. That is, the cycle characteristics of a lithium ion secondary battery tend to be improved.

In the present composite oxide, the ratio of the molar amount of Ni to the total molar amount (X) of Ni, Co and Mn (i.e. Ni/X) is preferably from 0.15 to 0.55. When Ni/X falls within the above range, the discharge capacity and discharge voltage of the lithium ion secondary battery can be made higher. Further, with a view to further increasing the discharge voltage of the lithium ion secondary battery, Ni/X is more preferably from 0.15 to 0.5, further preferably from 0.2 to 0.4.

In the present composite oxide, the ratio of the molar amount of Co to the total molar amount (X) of Ni, Co and Mn (i.e. Co/X) is preferably from 0 to 0.09. When CO/X is falls within the above range, the rate characteristics of the lithium ion secondary battery can be made higher. Further, with a view to further improving the cycle characteristics of the lithium ion secondary battery, Co/X is more preferably from 0 to 0.07, further preferably from 0 to 0.05.

In the present composite oxide, the ratio of the molar amount of Mn to the total molar amount (X) of Ni, Co and Mn (i.e. Mn/X) is preferably from 0.45 to 0.8. When Mn/X falls within the above range, the discharge voltage and discharge capacity of the lithium ion secondary battery can be made higher. Further, with a view to further increasing the discharge voltage of the lithium ion secondary battery, the upper limit for Mn/X is more preferably 0.78. With a view to further increasing the discharge capacity of the lithium ion secondary battery, the lower limit for Mn/X is more preferably 0.5.

In the present composite oxide, the ratio of the molar amount of Li to the total molar amount (X) of Ni, Co and Mn (i.e. Li/X) is preferably higher by from 2 to 16% than the theoretical composition ratio. Li/X is more preferably higher by from 2 to 14% than the theoretical composition ratio, more preferably higher by from 2 to 12% than the theoretical composition ratio. When Li/X is higher than the theoretical composition ratio, a in the formula I becomes large, and α>γ. Thus, it is possible to make the discharge capacity of a lithium iron secondary battery higher. Further, in the X-ray diffraction pattern, the logarithmic standard deviation of the crystalline size distribution obtained from a peak of (003) plane assigned to a crystal structure with space group R-3m tends to be at most 0.198. That is, the cycle characteristics of a lithium iron secondary battery tend to be improved. However, if Li/X is too higher than the theoretical composition ratio, the amount of free alkalis may be large due to excess Li. If a cathode active material containing a large amount of free alkalis is used, the coating property at a time of coating a positive electrode current collector deteriorates, and thereby the productivity deteriorates.

The present composite oxide may contain other elements other than Li, Ni, Co and Mn, as the case requires. Such other elements may, for example, be P, Mg, Ca, Ba, Sr, Al, Cr, Fe, Ti, Zr, Y, Nb, Mo, Ta, W, Ce, La, etc. The present composite present oxide preferably contain P as such other elements, whereby the cycle characteristics of the lithium ion secondary battery will be better. With a view to further increasing the discharge capacity of the lithium ion secondary battery, the present composite oxide preferably contains at least one member selected from the group consisting of Mg, Al, Cr, Fe, Ti and Zr.

The present composite oxide is a solid solution of Li(Li_{1/3}Mn_{2/3})O₂ (lithium excess phase) having a layered rock salt crystal structure with space group C2/m and LiNi_{α}Co_{β}Mn_{γ}O₂ having a layered rock salt crystal structure with space group R-3m. By an X-ray diffraction measurement, it can be confirmed that the solid solution type lithium-containing composite oxide has such crystal structures.

The X-ray diffraction measurement is carried out by the method and conditions as disclosed in Examples. The peak of (003) plane assigned to the crystal structure with space group R-3m is a peak which appears at 2θ=18 to 20 deg. The peak of (020) plane of the crystal structure with space group C2/m is a peak which appears at 2θ=20 to 22 deg. The peak of (110) plane assigned to the crystal structure with space group R-3m is a peak which appears at 28=64 to 66 deg.

In the present composite oxide, the logarithmic standard deviation of the crystalline size distribution obtained from a peak of (003) plane assigned to a crystal structure with space group R-3m is at most 0.198 in the X-ray diffraction pattern, whereby if charge and discharge cycle is repeated, the cycle characteristics of the lithium ion secondary battery are excellent.

In the solid solution lithium-containing composite oxide, what the logarithmic standard deviation of the crystalline size distribution obtained from a peak of (003) plane assigned to a crystal structure with space group R-3m is at most 0.198, means that the crystalline size distribution is narrow. By using the present composite oxide having a narrow crystalline size distribution as a cathode active material, heterogeneous reactions are reduced in charge and discharge reactions of the lithium ion secondary buttery, whereby the cycle characteristics of the lithium ion secondary battery are improved.

The logarithmic standard deviation of the crystalline size distribution is preferably at most 0.185, more preferably at most 0.180. The lower limit value of the logarithmic standard deviation of the crystalline size distribution is preferably 0.040.

In an X-ray diffraction pattern of the present composite oxide, the integrated intensity ratio (I₀₂₀/I₀₀₃) of the integral intensity (I₀₂₀) of a peak of (020) plane assigned to a crystal structure with space group C2/m to the integral intensity (I₀₀₃) of a peak of (003) plane assigned to a crystal structure with space group R-3m is preferably from 0.02 to 0.3. When I₀₂₀/I₀₀₃ falls within the above range, the present composite oxide has the said two crystal structures with good balance, whereby the discharge capacity of the lithium ion secondary buttery is easily made high. I₀₂₀/I₀₀₃ is preferably from 0.02 to 0.28, more preferably from 0.02 to 0.25, with a view to increasing the discharge capacity of the lithium ion secondary battery.

In a crystallite having a layered rock salt crystal structure with space group R-3m, during charging and discharging, each Li diffuses in the a-b axis direction, and getting in and out of Li occurs at ends of the crystallite. The c-axis direction of the crystallite is the lamination direction, and in a shape being long in the c-axis, the number of ends where Li can get in and out, increases as compared with other crystallites having the same volume. The crystallite diameter in the a-b axis direction is a crystallite diameter (D₁₁₀) obtained by the Scheller equation from a peak of (110) plane assigned to a crystal structure with space group R-3m in the X-ray diffraction pattern of the present composite oxide. The crystallite diameter in the c-axis direction is a crystallite diameter (D₀₀₃) obtained by the Scheller equation from a peak of (003) plane of space group R-3m in the X-ray diffraction pattern of the present composite oxide.

In the present composite oxide, D₀₀₃ is preferably from 60 to 140 nm, more preferably from 70 to 120 nm, further preferably from 80 to 115 nm. When D₀₀₃ is at least the above lower limit value, the cycle characteristics of the lithium ion secondary battery can easily be made good. When D₀₀₃ is at most the above upper limit value, the discharge capacity of the lithium ion secondary battery can easily be made high.

In the present composite oxide, D₁₁₀ is preferably from 30 to 80 nm, more preferably from 35 to 75 nm, further preferably from 40 to 70 nm. When Duo is at least the above lower limit value, the stability of the crystal structure will be improved. When D₀₀₃ is at most the above upper limit value, the cycle characteristics of the lithium ion secondary battery can easily be made good.

### (Function and Mechanism)

The above described present composite oxide is the lithium-containing composite oxide represented by the formula I, namely lithium rich cathode active material, whereby a lithium ion secondary battery excellent in discharge capacity can be obtained. Further, in an X-ray diffraction pattern, the logarithmic standard deviation of the crystalline size distribution obtained from a peak of (003) plane assigned to a crystal structure with space group R-3m is at most 0.198. That is, the crystalline size distribution is narrow, whereby heterogeneous reactions are reduced in charge and discharge reactions of a lithium ion secondary buttery. Thus, a lithium ion secondary battery which is excellent in cycle characteristics is obtained.

### <Process for Producing Lithium-Containing Composite Oxide>

The process for producing a lithium-containing composite oxide of the present invention (hereinafter referred to as “present production process”) is a process which comprises mixing a transition metals-containing compound essentially containing Ni and Mn and optionally containing Co with a lithium compound so that the ratio of the molar amount of Li to the total molar amount (X) of Ni, Co and Mn (i.e. Li/X) would be higher by from 2 to 16% than the theoretical composition ratio and firing the obtained mixture at from 980 to 1100° C.

In the present production process, Li/X in the mixture is higher than the theoretical composition ratio, and the mixture is fired at a firing temperature of at least 980° C. to produce a lithium-containing composite oxide. By using a lithium-containing composite oxide obtained by the present production process as a cathode active material, the discharge capacity of the lithium ion secondary battery is made high, and the cycle characteristics are made good. The reason why the cycle characteristics are made good is not clearly understood, however, it is considered as one of factors that in the X-ray diffraction pattern of the lithium-containing composite oxide obtained by the present production process, the logarithmic standard deviation of the crystalline size distribution obtained from a peak of (003) plane assigned to a crystal structure with space group R-3m is at most 0.198.

As one embodiment of the production process, a process comprising the following steps (a) to (b) may, for example, be mentioned.

(a) A step of obtaining a transition metal elements-containing compound essentially containing Ni and Mn and optionally containing Co.

(b) A step of mixing the transition metal elements-containing compound and a lithium compound, and firing the obtained mixture to obtain a lithium-containing composite oxide.

### Step (a):

The proportion of Ni, Co and Mn contained in the transition metals-containing compound is the same proportion of Ni, Co and Mn contained in the present composite oxide.

The transition metals-containing compound may, for example, be a hydroxide or a carbonate, and is preferably the hydroxide from the viewpoint of improving the cycle characteristics of the lithium iron secondary battery. The hydroxide includes an oxyhydroxide which is partially oxidized.

The transition metals-containing compound may, for example, be prepared by a coprecipitation method.

The coprecipitation method may, for example, be an alkali coprecipitation method or a carbonate coprecipitation method.

The alkali coprecipitation method is a method wherein an aqueous metal salt solution essentially containing Ni and Mn and optionally containing Co, and a pH adjusting liquid containing a strong alkali are continuously supplied to a reaction tank and mixed, and while keeping the pH in the mixture constant, hydroxides essentially containing Ni, Mn and optionally containing Co are precipitated.

The carbonate precipitation method is a method wherein an aqueous metal salt solution essentially containing Ni and Mn and optionally containing Co, and an aqueous carbonate solution containing an alkali metal, are continuously supplied to a reaction tank and mixed, and in the mixed liquid, carbonates essentially containing Ni and Mn and optionally containing Co are precipitated.

As the coprecipitation method, the alkali coprecipitation method is preferred, since the cycle characteristics of the lithium iron secondary battery are easily made good.

Now, the precipitation method for hydroxides will be described in detail with reference to the alkali coprecipitation method.

The metal salts may, for example, be nitrates, acetates, chlorides or sulfates of the respective transition metal elements, and sulfates are preferred in that the material costs are relatively inexpensive and excellent battery characteristics are thereby obtainable. As the metal salts, a sulfate of Ni, a sulfate of Mn and a sulfate of Co are more preferred.

The sulfate of Ni may, for example, be nickel(II) sulfate hexahydrate, nickel(II) sulfate heptahydrate or nickel(II) ammonium sulfate hexahydrate.

The sulfate of Co may, for example, be cobalt(II) sulfate heptahydrate or cobalt(II) ammonium sulfate hexahydrate.

The sulfate of Mn may, for example, be manganese(II) sulfate pentahydrate or manganese(II) ammonium sulfate hexahydrate.

The ratio of Ni, Co and Mn in the aqueous metal salt solution is adjusted to be the same as the ratio of Ni, Co and Mn to be contained in the finally obtainable lithium-containing composite oxide.

The total concentration of Ni, Co and Mn in the aqueous metal salt solution is preferably from 0.1 to 3 mol/kg, more preferably from 0.5 to 2.5 mol/kg. When the total concentration of Ni, Co and Mn is at least the above lower limit value, the productivity will be excellent. When the total concentration of Ni, Co and Mn is at most the above upper limit value, the metal salts can be sufficiently dissolved in water.

The aqueous metal salt solution may contain an aqueous medium other than water.

The aqueous medium other than water, may, for example, be methanol, ethanol, 1-propanol, 2-propanol, ethylene glycol, propylene glycol, diethylene glycol, dipropylene glycol, polyethylene glycol, butanediol or glycerine. The proportion of the aqueous medium other than water is preferably from 0 to 20 parts by mass, more preferably from 0 to 10 parts by mass, particularly preferably from 0 to 1 part by mass, per 100 parts by mass of water from the viewpoint of safety, environmental aspect, handling efficiency and costs.

The pH adjusting liquid is preferably an aqueous solution containing a strong alkali.

The strong alkali is preferably at least one member selected from the group consisting of sodium hydroxide, potassium hydroxide and lithium hydroxide.

To the mixed liquid, a complexing agent (aqueous ammonia or an aqueous ammonium sulfate solution) may be added to adjust the solubility of Ni ions, Co ions and Mn ions.

The aqueous metal salt solution and the pH adjusting liquid are preferably mixed with stirring in the reaction tank.

The stirring device may, for example, be a three-one motor. The stirring blades may, for example, be anchor-type, propeller-type or paddle-type.

The reaction temperature is preferably from 20 to 80° C., more preferably from 25 to 60° C., with a view to accelerating the reaction.

Mixing of the aqueous metal salt solution and the pH adjusting liquid is preferably conducted in a nitrogen atmosphere or in an argon atmosphere, with a view to preventing oxidation of the hydroxides, and it is particularly preferably conducted in a nitrogen atmosphere from the viewpoint of costs.

During the mixing of the aqueous metal salt solution and the pH adjusting liquid, it is preferred to maintain the pH in the reaction tank to be a pH set within a range of from 10 to 12, with a view to letting the coprecipitation reaction proceed properly. When the mixing is conducted at a pH of at least 10, coprecipitates are deemed to be hydroxides.

As the method for precipitating hydroxides, two types may be mentioned, i.e. a method (hereinafter referred to as a concentration method) of carrying out the precipitation reaction while concentrating hydroxides by withdrawing the mixed liquid in the reaction tank through a filter (e.g. a filter cloth), and a method (hereinafter referred to as an overflow method) of carrying out the precipitation reaction while maintaining the concentration of hydroxides to be low by withdrawing the mixed liquid in the reaction tank, together with the hydroxides, without using a filter. The concentration method is preferred, with a view to narrowing the particle size distribution.

The hydroxides are preferably washed to remove impurity ions. The washing method may, for example, be a method of repeating pressure filtration and dispersion into distilled water. Such washing is preferably repeated until the electrical conductivity of the filtrate or the supernatant at the time when the hydroxides are dispersed in distilled water, becomes to be at most 50 mS/m, more preferably repeated until the electrical conductivity becomes to be at most 20 mS/m.

After the washing, the hydroxides may be dried as the case requires.

The drying temperature is preferably from 60 to 200° C., more preferably from 80 to 130° C. When the drying temperature is at least the above lower limit value, the drying time can be shortened. When the drying temperature is at most the above upper limit value, it is possible to prevent the progress of oxidation of the hydroxides.

The drying time may be properly set depending upon the amount of the hydroxides and is preferably from 1 to 300 hours, more preferably from 5 to 120 hours.

The specific surface area of the transition metals-containing compound is preferably from 3 to 60 m²/g, more preferably from 5 to 50 m²/g. When the specific surface area of the transition metals-containing compound is within the above range, the specific surface area of the active material can be easily controlled to be within a preferred range. Here, the specific surface area of the transition metals-containing compound is a value measured after the precursor is dried at 120° C. for 15 hours.

D₅₀ of the transition metals-containing compound is preferably from 3 to 15.5 μm, more preferably from 3 to 12.5 μm, further preferably from 3 to 10.5 μm. When D₅₀ of the transition metals-containing compound is within the above range, D₅₀ of the present active material can be easily controlled to be within a preferred range.

### Step (b):

The transition metals-containing compound and a lithium compound are mixed, and the obtained mixture is fired, whereby a lithium-containing composite oxide will be formed.

The lithium compound is preferably one member selected from the group consisting of lithium carbonate, lithium hydroxide and lithium nitrate. Lithium carbonate is more preferred from the viewpoint of handling efficiency in the production steps.

The method for mixing the transition metals-containing compound and the lithium compound may, for example, be a method of using a rocking mixer, a Nauta mixer, a spiral mixer, a cutter mill or a V mixer.

The ratio of the molar amount of Li contained in the lithium compound to the total molar amount (X) of Ni, Co and Mn contained in the transition metals-containing compound (Li/X) is a ratio higher by from 2 to 16% than the theoretical composition ratio in the lithium-containing composite oxide represented by the formula I. Li/X is preferably higher by from 2 to 14% than the theoretical composition ratio, more preferably higher by from 2 to 12% than the theoretical composition ratio. When Li/X is higher than the theoretical composition ratio, a becomes large in the formula I, and a>γ. Thus, the discharge capacity of a lithium ion secondary battery is made higher. Further, in the X-ray diffraction pattern, the logarithmic standard deviation of the crystalline size distribution obtained from a peak of (003) plane assigned to a crystal structure with space group R-3m is easily made to be at most 0.198. That is, the cycle characteristics of the lithium ion secondary are easily made good. However, if Li/X is too higher than the theoretical composition ratio, the amount of free alkalis may be large due to excess Li. If a cathode active material containing a large amount of free alkalis is used, the coating property of coating a cathode current collector becomes poor, and thereby the productivity deteriorates.

The firing apparatus may, for example, be an electric furnace, a continuous firing furnace or a rotary kiln.

During the firing, the transition metals-containing compound is oxidized, and therefore, the firing is preferably conducted in the atmospheric air, and it is particularly preferred to carry out the firing while supplying air.

The supply rate of air is preferably from 10 to 200 mL/min., more preferably from 40 to 150 mL/min., per 1 L of the inner volume of the furnace.

By supplying air during the firing, the metal elements in the transition metals-containing compound will be sufficiently oxidized, whereby it is possible to obtain the present composite oxide having a high crystallinity and having a crystal structure with space group C2/m and a crystal structure with space group R-3m.

The firing temperature is from 980 to 1,100° C., preferably from 980 to 1,075° C., more preferably from 980 to 1,050° C. By using a lithium-containing composite oxide having Li/X higher than the theoretical composition ratio and produced at the firing temperature of at least the lower limit of the above range, is used as a cathode active material, the cycle characteristics of the lithium ion secondary will be good. Further, by producing under the above condition, a lithium-containing composite oxide having in an X-ray diffraction pattern, at most 0.198 of the logarithmic standard deviation of the crystalline size distribution obtained from a peak of (003) plane assigned to a crystal structure with space group R-3m, can be obtained. When the firing temperature is at most the upper limit value of the above range, Li can be prevented from volatilizing in the firing step, and thereby a lithium-containing composite oxide having the ratio of charged Li can be obtained.

The firing time is preferably from 4 to 40 hours, more preferably from 4 to 20 hours.

The firing may be one-stage firing or two-stage firing i.e. temporary firing followed by main firing. The two-stage firing is preferred since Li thereby tends to be readily uniformly dispersed in the present composite oxide. In a case where the two-stage firing is carried out, the main firing is carried out within the above mentioned range of the firing temperature. Further, the temperature for the temporary firing is preferably from 400 to 700° C., more preferably from 500 to 650° C.

### (Function and Mechanism)

In the above described present production process, a transition metals-containing compound essentially containing Ni and Mn and optionally containing Co is mixed with a lithium compound so that the ratio of the molar amount of Li to the total molar amount (X) of Ni, Co and Mn (i.e. Li/X) would be higher by from 2 to 16% than the theoretical composition ratio, and the obtained mixture is fired at from 980 to 1100° C. With a lithium-containing composite oxide obtained by the present production process, the discharge capacity and the cycle characteristics of the lithium ion secondary buttery are made good.

### <Cathode Active Material>

The cathode active material of the present invention (hereinafter referred to also as “present cathode active material”) may be the present composite oxide itself or a lithium-containing composite oxide itself obtained by the present production process, or a surface-treated present composite oxide or a surface-treated lithium-containing composite oxide obtained by the present production process.

The surface treatment is a treatment to coat a surface of the present composite oxide or a surface of a lithium-containing composite oxide obtained by the present production process with a material (surface-coating material) having a different composition from the material constituting the present composite oxide or the lithium-containing composite oxide obtained by the present production process. The surface-coating material may, for example, be an oxide (such as aluminum oxide, silicon oxide, titanium oxide, zirconium oxide, magnesium oxide, calcium oxide, boron oxide, antimony oxide or bismuth oxide), a sulfate (such as sodium sulfate, potassium sulfate, magnesium sulfate, calcium sulfate or aluminum sulfate) or a carbonate (such as calcium carbonate or magnesium carbonate).

The mass of the surface coating material is preferably at least 0.01 mass %, more preferably at least 0.05 mass %, particularly preferably at least 0.1 mass %, per the mass of the present composite oxide or the mass of the lithium-containing composite oxide obtained by the present production process. The mass of the surface coating material is preferably at most 10 mass %, more preferably at most 5 mass %, particularly preferably at most 3 mass %, per the mass of the present composite oxide or the mass of the lithium-containing composite oxide obtained by the present production process. When the surface coating material is present on a surface of the present composite oxide or a surface of the lithium-containing composite oxide obtained by the present production process, the oxidation reaction of a non-aqueous electrolyte on the surface of the present composite oxide or the surface of the lithium-containing composite oxide obtained by the present production process can be prevented, whereby the life span of a battery can be improved.

In a case where the present composite oxide or the lithium-containing composite oxide obtained by the present production process is subjected to surface treatment, the surface treatment may be carried out by spraying a predetermined amount of a liquid (coating liquid) containing a surface coating material to the present composite oxide or the lithium-containing composite oxide obtained by the present production process, followed by firing to remove a solvent of the coating liquid, or may be carried out by dipping the present composite oxide or the lithium-containing composite oxide obtained by the present production process in a coating liquid, followed by carrying out solid-liquid separation by filtration and firing to remove a solvent.

The cathode active material of the present invention is preferably secondary particles in which plural primary particles are coaggregated.

D₅₀ of the secondary particles of the present cathode active material is preferably from 3 to 15 μm, more preferably from 4 to 12 μm, further preferably from 5 to 10 μm. When D₅₀ is within the above range, the discharge capacity of the lithium iron secondary battery can easily be made high.

The specific surface are of the cathode active material is preferably from 0.5 to 4 m²/g, more preferably from 0.7 to 3.5 m²/g, further preferably from 1 to 3 m²/g. When the specific surface area is at least the above lower limit value, the discharge capacity of the lithium iron secondary battery can be easily made high. When the specific surface are is at most the above upper limit of the above range, the cycle characteristics of the lithium iron secondary battery can be easily made good.

### (Function and Mechanism)

The above described present cathode active material comprises so called a lithium rich cathode active material, whereby a lithium ion secondary battery excellent in discharge capacity can be obtained. Further, in an X-ray diffraction pattern, the logarithmic standard deviation of the crystalline size distribution obtained from a peak of (003) plane assigned to a crystal structure with space group R-3m is at most 0.198. That is, the present composite oxide having a narrow crystalline size distribution is contained, whereby heterogeneous reactions are reduced in charge and discharge reactions of the lithium ion secondary buttery. Thus, the lithium ion secondary battery which is excellent in the cycle characteristics is obtained.

### <Positive Electrode for Lithium Ion Secondary Battery>

The positive electrode for a lithium ion secondary battery of the present invention (hereinafter referred to as the present positive electrode) comprises the present cathode active material. Specifically, it has a cathode active material layer comprising the present active material, an electrically conductive material and a binder, formed on a positive electrode current collector.

As the electrically conductive material, carbon black (such as acetylene black or Ketjen black), graphite, vapor-grown carbon fibers or carbon nanotubes may, for example, be mentioned.

As the binder, a fluorinated resin (such as polyvinylidene fluoride or polytetrafluoroethylene), a polyolefin (such as polyethylene or polypropylene), a polymer or copolymer having unsaturated bonds (such as a styrene/butadiene rubber, an isoprene rubber or a butadiene rubber) or an acrylic polymer or copolymer (such as an acrylic copolymer or a methacrylic copolymer) may, for example, be mentioned.

As the positive electrode current collector, an aluminum foil or a stainless steel foil may, for example, be mentioned.

The present positive electrode may be produced, for example, by the following method.

The present cathode active material, the electrically conductive material and the binder are dissolved or dispersed in a medium to obtain a slurry. The obtained slurry is applied to the positive electrode current collector, and the medium is removed e.g. by drying to form a layer of the cathode active material. As the case requires, the layer of the cathode active material may be pressed e.g. by roll pressing. The present positive electrode is obtained in such a manner.

Otherwise, the present cathode active material, the electrically conductive material and the binder are kneaded with a medium to obtain a kneaded product. The obtained kneaded product is pressed on the positive electrode current collector to obtain the present positive electrode.

### (Function and Mechanism)

The above-described present positive electrode contains the present cathode active material, whereby it is possible to obtain a lithium ion secondary battery excellent in the discharge capacity and the cycle characteristics.

### <Lithium Ion Secondary Battery>

The lithium ion secondary battery of the present invention (hereinafter referred to as the present battery) has the present positive electrode. Specifically, it comprises the present positive electrode, a negative electrode and a non-aqueous electrolyte.

### (Negative Electrode)

The negative electrode contains an anode active material. Specifically, it has an anode active material layer containing an anode active material and as the case requires an electrically conductive material and a binder, formed on a negative electrode current collector.

The anode active material may be any material so long as it is capable of absorbing and desorbing lithium ions at a relatively low potential. The anode active material may, for example, be a lithium metal, a lithium alloy, a lithium compound, a carbon material, an oxide composed mainly of a metal in Group 14 of the periodic table, an oxide composed mainly of a metal in Group 15 of the periodic table, a carbon compound, a silicon carbide compound, a silicon oxide compound, titanium sulfide or a boron carbide compound.

The carbon material as the anode active material may, for example, be non-graphitized carbon, artificial graphite, natural graphite, thermally decomposed carbon, cokes (such as pitch coke, needle coke or petroleum coke), graphites, glassy carbons, an organic polymer compound fired product (product obtained by firing and carbonizing a phenol resin, a furan resin or the like at an appropriate temperature), carbon fibers, activated carbon or carbon blacks.

The metal in Group 14 of the periodic table to be used as the anode active material may be Si or Sn, and is preferably Si.

As another anode active material, an oxide such as iron oxide, ruthenium oxide, molybdenum oxide, tungsten oxide, titanium oxide or tin oxide, or a nitride may, for example, be mentioned.

As the electrically conductive material and the binder for the negative electrode, the same ones as for the positive electrode may be used.

As the negative electrode current collector, a metal foil such as a nickel foil or a copper foil may be mentioned.

The negative electrode may be produced, for example, by the following method.

The anode active material, the electrically conductive material and the binder are dissolved or dispersed in a medium to obtain a slurry. The obtained slurry is applied to the negative electrode current collector, and the medium is removed e.g. by drying, followed by pressing to obtain the negative electrode.

### (Non-Aqueous Electrolyte)

The non-aqueous electrolyte may, for example, be a non-aqueous electrolytic solution having an electrolyte salt dissolved in an organic solvent; an inorganic solid electrolyte; or a solid or gelled polymer electrolyte in which an electrolyte salt is mixed or dissolved.

The organic solvent may be an organic solvent known for a non-aqueous electrolytic solution. Specifically, it may, for example, be propylene carbonate, ethylene carbonate, diethyl carbonate, dimethyl carbonate, 1,2-dimethoxyethane, 1,2-diethoxyethane, γ-butyrolactone, diethyl ether, sulfolane, methyl sulfolane, acetonitrile, an acetic acid ester, a butyric acid ester or a propionic acid ester. In view of the voltage stability, preferred is a cyclic carbonate (such as propylene carbonate) or a chain-structured carbonate (such as dim ethyl carbonate or diethyl carbonate). As the organic solvent, one type may be used alone, or two or more types may be used in combination.

As the inorganic solid electrolyte, a material having lithium ion conductivity may be used.

The inorganic solid electrolyte may, for example, be lithium nitride or lithium iodide.

As the polymer to be used for the solid polymer electrolyte, an ether polymer compound (such as polyethylene oxide or its crosslinked product), a polymethacrylate ester polymer compound or an acrylate polymer compound may, for example, be mentioned. As the polymer compound, one type may be used alone, or two or more types may be used in combination.

As the polymer to be used for the gelled polymer electrolyte, a fluorinated polymer compound (such as polyvinylidene fluoride or a vinylidene fluoride/hexafluoropropylene copolymer), polyacrylonitrile, an acrylonitrile copolymer or an ether polymer compound (such as polyethylene oxide or its crosslinked product) may, for example, be mentioned. As a monomer to be copolymerized to obtain the copolymer, polypropylene oxide, methyl methacrylate, butyl methacrylate, methyl acrylate or butyl acrylate may, for example, be mentioned.

The polymer compound is preferably a fluorinated polymer compound in view of the stability against the redox reaction.

As the electrolyte salt, any one of those commonly used for a lithium ion secondary battery may be used. The electrolyte salt may, for example, be LiClO₄, LiPF₆, LiBF₄ or CH₃SO₃Li.

Between the positive electrode and the negative electrode, a separator may be interposed so as to prevent short-circuiting. As the separator, a porous film may be mentioned. The porous film is used as impregnated with the non-aqueous electrolytic solution. Further, the porous film impregnated with the non-aqueous electrolytic solution, followed by gelation, may be used as a gelled electrolyte.

As a material of a battery exterior package, nickel-plated iron, stainless steel, aluminum or its alloy, nickel, titanium, a resin material or a film material may, for example, be mentioned.

The shape of the lithium ion secondary battery may, for example, be a coin-shape, a sheet-form (film-form), a folded shape, a wound cylinder with bottom, or a button shape, and is suitably selected depending upon the intended use.

### (Function and Mechanism)

The above-described present battery has the present positive electrode, whereby it is excellent in the discharge capacity and the cycle characteristics.

### EXAMPLES

Now, the present invention will be described in detail with reference to Examples, but it should be understood that the present invention is by no means thereby restricted.

Ex. 1 to 10 are Examples of the present invention, and Ex. 11 to 13 are Comparative Examples.

### (Particle Size)

The hydroxide or the cathode active material was sufficiently dispersed in water by ultrasonic treatment, and the measurement was conducted by a laser diffraction/scattering type particle size distribution measuring apparatus (MT-3300EX manufactured by NIKKISO CO., LTD.), to obtain the frequency distribution and accumulative volume distribution curve, whereby the volume-based particle size distribution was obtained. From the obtained accumulative volume distribution curve, D₅₀ was obtained.

### (Specific Surface Area)

The specific surface area of the hydroxide or the cathode active material was calculated by a nitrogen adsorption BET method using a specific surface area measuring apparatus (HM model-1208, manufactured by Mountech Co., Ltd.). Degassing was carried out at 200° C. for 20 minutes.

### (Composition Analysis)

Composition analysis of the lithium-containing composite oxide was carried out by a plasma emission spectroscope (SPS3100H manufactured by SII NanoTechnology Inc.). From the ratio of the molar amounts of Li, Ni, Co and Mn obtained from the composition analysis, a, α, β and γ in aLi(Li_{1/3}Mn_{2/3})O₂.(1−a)LiNi_{α}Co_{β}Mn_{γ}O₂ were calculated.

### (X-Ray Diffraction)

The X-ray diffraction of the lithium-containing composite oxide was measured by means of an X-ray diffraction apparatus (manufactured by Rigaku Corporation, apparatus name: SmartLab). The measurement conditions are shown in Table 1. The measurement was carried out at 25° C. Before the measurement, 1 g of the lithium-containing composite oxide and 30 mg of standard sample 640d for X-ray diffraction were mixed in an agate mortar, and this mixture was used as the sample for the measurement.

With respect to the obtained X-ray diffraction pattern, peak search was carried out using integrated X-ray powder diffraction software PDXL2 manufactured by Rigaku Corporation. From the respective peaks, D₀₀₃, D₁₁₀, and I₀₂₀/I₀₀₃ were obtained.

TABLE 1

| | | |
|---|---|---|
| Apparatus | Measurement apparatus | SmartLab manufactured by Rigaku |
| condition | | Corporation |
| | Target | Cu |
| | Detector | D/teX Ultra HE manufactured by Rigaku |
| | | Corporation |
| | Detector baseline | 44 div |
| | Detector window | 8 div |
| | Gonio length | 300 mm |
| | Soller/PSC | 5.0 (deg.) |
| | IS long dimension | 10 (mm) |
| | PSA | Open |
| | Soller | 5.0 (deg.) |
| | Monochromatization | Kβ filter method |
| | method | |
| Sample | Sample holder | Diameter: 24 mm, depth: 0.5 mm |
| condition | Rotation of sample during | Rotated (30 rpm) |
| | measurement | |
| Measurement | Measurement method | General purpose measurement (focal |
| condition | | method) |
| | Scanning axis | 2θ/θ |
| | Mode | Continuous |
| | Range specification | Absolute |
| | Initiation (deg.) | 15 (deg.) |
| | Termination (deg.) | 75 (deg.) |
| | Step (deg.) | 0.0052 (deg.) |
| | Speed measurement time | 1 (deg./min.) |
| | IS (deg.) | ⅓ (deg.) |
| | RS1 (mm) | 8 (mm) |
| | RS2 (mm) | 13 (mm) |
| | Attenuator | Open |
| | Tube voltage (kV) | 45 (kV) |
| | Tube current (mA) | 200 (mA) |
| Data | Analysis software | PDXL2 manufactured by Rigaku |
| processing | | Corporation |
| condition | Smoothing | Smoothing by B-Spline, X threshold: 1.50 |
| | Background removal | Fitting |
| | Kα2 removal | Intensity ratio: 0.4970 |
| | Peak search | Secondary differentiation, σ cut: 3.00 |
| | Profile fitting | Fitting of measurement data |
| | Peak shape | Variance pseudo-voigt function |

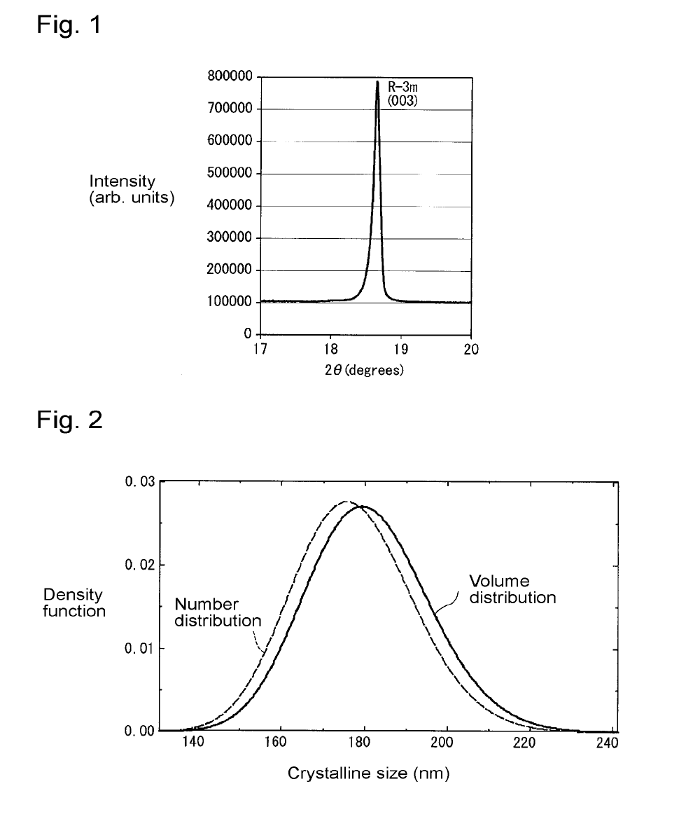

Further, in an X-ray diffraction pattern of the lithium-containing composite oxide, a profile (2θ=17.002 to 20.2 deg) of a peak of (003) plane assigned to a crystal structure with space group R-3m as illustrated in FIG. 1 was analyzed by using the crystalline size distribution analysis software CSDA (Ver. 1.3) manufactured by Rigaku Corporation with the following configuration, and the crystalline size distribution illustrated in FIG. 2 was obtained.

[Instrument Parameters]

Goniometer Radius: 300,

Axial Divergence: 5,

Equatorial Divergence: 0.3333333.

[Sample Parameters]

Sample Width: 20,

Sample Thickness: 0.5,

Linear Abs. Coef.: 20.

The logarithmic standard deviation of the crystalline size distribution was obtained from the crystalline size distribution (number distribution) by the crystalline size distribution analysis software CSDA (Ver. 1.3) manufactured by Rigaku Corporation.

### (Production of Positive Electrode Sheet)

The cathode active material obtained in each Ex., a conductive carbon black as an electrically conductive material and polyvinylidene fluoride as a binder were weighed in a mass ratio of 88:6:6, and they were added to N-methylpyrrolidone to prepare a slurry.

The slurry was applied on one side of an aluminum foil as a positive electrode current collector having a thickness of 20 μm by means of a doctor blade. The gap of the doctor blade was adjusted so that the thickness of the sheet after roll pressing would be 20 μm. After drying at 120° C., roll pressing was carried out twice to prepare a positive electrode sheet.

### (Production of Lithium Secondary Battery)

One having the positive electrode sheet punched out into a rectangular shape of 24×40 mm, was used as a positive electrode.

Artificial graphite was used as a negative electrode material, and one having the negative electrode sheet punched out into a rectangular shape of 44×28 mm, was used as a negative electrode.

As a separator, a porous polypropylene having a thickness of 25 μm was used.

As an electrolytic solution, a liquid having LiPF₆ dissolved at a concentration of 1 mol/dm³ in a solvent mixture of ethylene carbonate and diethyl carbonate in a volume ratio of 3:7, was used.

Using the positive electrode, the negative electrode, the separator and the aqueous electrolytic solution, a laminate type lithium secondary battery was assembled in a globe box.

### (Activation Treatment)

With respect to the lithium secondary battery using the cathode active material in each Ex., the activation treatment was carried out by constant current charging to 4.75 V with a load current of 26 mA per 1 g of the cathode active material, followed by low constant current discharging to 2 V with a load current of 26 mA per 1 g of the cathode active material.

### (Cycle Test)

With respect to the activation-treated lithium secondary battery, constant current and constant voltage charging was carried out to 4.45V for 90 minutes with a load current of 200 mA per 1 g of the cathode active material. Thereafter, constant current discharging was carried out to 2.0V with a load current of 200 mA per 1 g of the cathode active material. The first time discharge capacity was measured as the initial discharge capacity. Such a charge and discharge cycle was repeated in a total of 100 times. The cycle retention rate (%) was obtained by the following formula, from the discharge capacity in the 2nd cycle and the discharge capacity in the 100th cycle.

Cycle retention rate (%)=Discharge capacity in 100th cycle/discharge capacity in 2nd cycle×100

### Ex. 1

Nickel(II) sulfate hexahydrate and manganese(II) sulfate pentahydrate were dissolved in distilled water so that the molar ratio of Ni and Mn would be the ratio as shown in Table 2, and the total amount of the sulfates would be 1.5 mol/kg to obtain an aqueous sulfate solution.

As a pH adjusting solution, sodium hydroxide was dissolved in distilled water so that the concentration would be 1.5 mol/kg to obtain an aqueous sodium hydroxide solution.

As a complexing agent, ammonium sulfate was dissolved in distilled water so that the concentration would be 1.5 mol/kg to obtain an aqueous ammonium sulfate solution.

### Step (a)

Into a 2 L baffle-equipped glass reactor, distilled water was put and heated to 50° C. by a mantle heater. While stirring the liquid in the reactor by a paddle type stirring blade, the aqueous sulfate solution was added at a rate of 5.0 g/min and the aqueous ammonium sulfate solution was added at a rate of 0.5 g/min, for 12 hours, and the pH adjusting solution was added to maintain the pH of the mixed solution to be 10.5, to precipitate hydroxides containing Ni and Mn. During the addition of the raw material solutions, nitrogen gas was made to flow at a rate of 1.0 L/min in the reactor. Further, a liquid containing no hydroxide was continuously withdrawn using filter cloth, so that the liquid amount in the reactor would not exceed 2 L. In order to remove impurity ions from the obtained hydroxides, pressure filtration and dispersion in distilled water were repeated for washing. Washing was completed at a point where the electrical conductivity of the filtrate became 20 mS/m, and the hydroxides were dried at 120° C. for 15 hours.

### Step (b):

The hydroxides and lithium carbonate were mixed so that the ratio in molar amount of Li to X (X is Ni and Mn) (i.e. Li/X) would be the ratio mentioned in Table 3, to obtain a mixture.

In an electric furnace, while supplying air, the mixture was subjected to temporary firing at 600° C. in air over a period of 3 hours to obtain a temporarily fired product.

In an electric furnace, while supplying air, the temporarily fired product was subjected to main firing at 990° C. in air over a period of 16 hours to obtain a lithium-containing composite oxide. This lithium-containing composite oxide was used as a cathode active material.

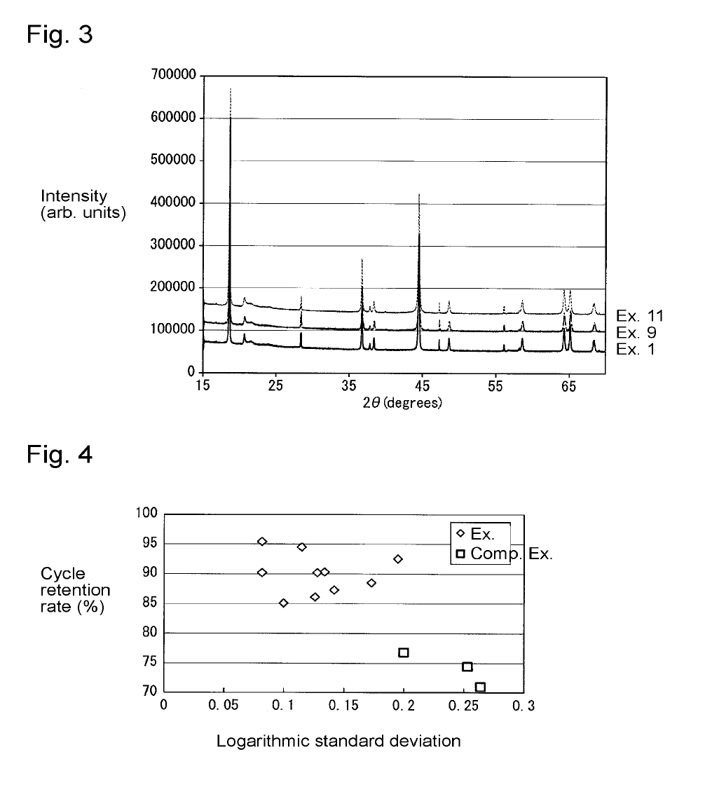

The results are shown in Tables 2, 3 and 4. The X-ray diffraction pattern of the lithium-containing composite oxide is shown in FIG. 3. The relation between the logarithmic standard deviation of the crystalline size distribution and the cycle retention rate is shown in FIG. 4.

### Ex. 2

1.07 g of a basic aluminum lactate aqueous solution (Takiceram KML6, Al content: 8.5 mass % as calculated as Al₂O₃, manufactured by Taki Chemical Ltd.) was sprayed to 10 g of the lithium-containing composite oxide of Ex. 1 to contact the lithium-containing composite oxide with the Al aqueous solution while mixing. The obtained mixture was dried at 90° C. for 3 hours and then heated at 450° C. for 5 hours under an oxygen-containing atmosphere to obtain a cathode active material comprising the lithium-containing composite oxide of which surface was coated with the Al compound.

The results are shown in Tables 2, 3 and 4. The relation between the logarithmic standard deviation of the crystalline size distribution and the cycle retention rate is shown in FIG. 4.

### Ex. 3 to 8, 11 and 12

Lithium-containing composite oxides in Ex. 3 to 8, 11 and 12 were obtained in the same manner as in Ex. 1 except that the conditions were changed as shown in Tables 2 and 3. The lithium-containing composite oxides were used as cathode active materials. The results are shown in Tables 2, 3 and 4. The X-ray diffraction patterns of the lithium-containing composite oxide in Ex. 11 is shown in FIG. 3. The relation between the logarithmic standard deviation of the crystalline size distribution and the cycle retention rate in Ex. 3 to 8, 11 and 12 is shown in FIG. 4.

### Ex. 9, 10 and 13

Lithium-containing composite oxides in Ex. 9, 10 and 13 were obtained in the same manner as in Ex. 1 except that the conditions was changed as shown in Table 3, and a commercially available hydroxide was used as the hydroxide. The lithium-containing composite oxides were used as cathode active materials. The results are shown in Tables 2, 3 and 4. The X-ray diffraction patterns of the lithium-containing composite oxide in Ex. 9 is shown in FIG. 3. The relation between the logarithmic standard deviation of the crystalline size distribution and the cycle retention rate in Ex. 9, 10 and 13 is shown in FIG. 4.

TABLE 2

| | Step (a) | | | | | | | | Hydroxide | |
|---|---|---|---|---|---|---|---|---|---|---|
| | | | | Complexing | | | | Reaction | | Specific |
| | Charge [mol %] | | | agent | Initial | Controlled | Reaction | temp. | D₅₀ | surface area |
| Ex. | Ni | Co | Mn | NH₄/X | pH | pH | time [hr] | [° C.] | [μm] | [m²/g] |
| 1 | 25.0 | 0.0 | 75.0 | 0.1 | 10.5 | 10.5 | 12 | 50 | 6.5 | 42.0 |
| 2 | 25.0 | 0.0 | 75.0 | 0.1 | 10.5 | 10.5 | 12 | 50 | 6.5 | 42.0 |
| 3 | 25.0 | 0.0 | 75.0 | 0.1 | 10.5 | 10.5 | 12 | 50 | 6.5 | 42.0 |
| 4 | 25.0 | 0.0 | 75.0 | 0.1 | 11 | 11 | 28 | 50 | 5.3 | 24.3 |
| 5 | 13.6 | 0.0 | 86.4 | 0.1 | 7 | 11 | 14 | 50 | 7.3 | 46.7 |
| 6 | 34.6 | 0.0 | 65.4 | 0.1 | 7 | 11 | 14 | 50 | 3.9 | 28.0 |
| 7 | 30.0 | 0.0 | 70.0 | 0.1 | 10.5 | 10.5 | 28 | 50 | 5.5 | 25.9 |
| 8 | 32.3 | 4.6 | 63.1 | 0.1 | 11 | 11 | 14 | 50 | 4.7 | 37.7 |
| 9 | 25.0 | 0.0 | 75.0 | — | — | — | — | — | 5.2 | 44.7 |
| 10 | 25.0 | 0.0 | 75.0 | — | — | — | — | — | 5.2 | 44.7 |
| 11 | 25.0 | 0.0 | 75.0 | 0.1 | 10.5 | 10.5 | 13 | 50 | 7.0 | 39.5 |
| 12 | 25.0 | 0.0 | 75.0 | 0.1 | 10.5 | 10.5 | 13 | 50 | 7.0 | 39.5 |
| 13 | 25.0 | 0.0 | 75.0 | — | — | — | — | — | 5.2 | 44.7 |

TABLE 3

| | Step (b) | | | | | | |
|---|---|---|---|---|---|---|---|
| | Li/X | | | Temporary | | | |
| | Theoretical | | | firing | | Main firing | |
| | composition | | Increment | Temp. | Time | Temp. | Time |
| Ex. | ratio | Mixture | [%] | [° C.] | [hr] | [° C.] | [hr] |
| 1 | 1.50 | 1.580 | 5.3 | 600 | 3 | 990 | 16 |
| 2 | 1.50 | 1.580 | 5.3 | 600 | 3 | 990 | 16 |
| 3 | 1.50 | 1.540 | 2.7 | 600 | 3 | 1035 | 16 |
| 4 | 1.50 | 1.580 | 5.3 | 600 | 3 | 990 | 16 |
| 5 | 1.73 | 1.770 | 2.5 | 600 | 3 | 990 | 16 |
| 6 | 1.31 | 1.420 | 8.6 | 600 | 3 | 990 | 16 |
| 7 | 1.40 | 1.490 | 6.4 | 600 | 3 | 990 | 16 |
| 8 | 1.31 | 1.410 | 7.8 | 600 | 3 | 990 | 16 |
| 9 | 1.50 | 1.580 | 5.3 | 600 | 3 | 990 | 16 |
| 10 | 1.50 | 1.620 | 8.0 | 600 | 3 | 990 | 16 |
| 11 | 1.50 | 1.580 | 5.3 | 600 | 3 | 965 | 16 |
| 12 | 1.50 | 1.540 | 2.7 | 600 | 3 | 920 | 16 |
| 13 | 1.50 | 1.580 | 5.3 | 600 | 3 | 960 | 16 |

| | Lithium-containing composite oxide | | | | | | | | |
|---|---|---|---|---|---|---|---|---|---|
| | | | | | aLi(Li_{1/3}Mn_{2/3})O₂•(1 − | | | | |
| | Analyzed composition | | | | a)LiNi_{α}Co_{β}Mn_{γ}O₂ | | | | |
| Ex. | Li/X | Ni/X | Co/X | Mn/X | a | α | β | γ | α − γ |
| 1 | 1.539 | 0.251 | 0.000 | 0.749 | 0.637 | 0.544 | 0.000 | 0.456 | 0.088 |
| 2 | 1.539 | 0.251 | 0.000 | 0.749 | 0.637 | 0.544 | 0.000 | 0.456 | 0.088 |
| 3 | 1.526 | 0.250 | 0.000 | 0.750 | 0.625 | 0.527 | 0.000 | 0.473 | 0.054 |
| 4 | 1.564 | 0.250 | 0.000 | 0.750 | 0.660 | 0.575 | 0.000 | 0.425 | 0.150 |
| 5 | 1.430 | 0.347 | 0.000 | 0.653 | 0.530 | 0.608 | 0.000 | 0.392 | 0.215 |
| 6 | 1.485 | 0.299 | 0.000 | 0.701 | 0.585 | 0.580 | 0.000 | 0.420 | 0.160 |
| 7 | 1.402 | 0.323 | 0.046 | 0.631 | 0.502 | 0.540 | 0.077 | 0.383 | 0.157 |
| 8 | 1.553 | 0.253 | 0.000 | 0.747 | 0.650 | 0.567 | 0.000 | 0.433 | 0.134 |
| 9 | 1.592 | 0.253 | 0.000 | 0.747 | 0.685 | 0.620 | 0.000 | 0.380 | 0.239 |
| 10 | 1.529 | 0.252 | 0.000 | 0.748 | 0.628 | 0.536 | 0.000 | 0.464 | 0.072 |
| 11 | 1.572 | 0.250 | 0.000 | 0.750 | 0.667 | 0.584 | 0.000 | 0.416 | 0.168 |
| 12 | 1.540 | 0.250 | 0.000 | 0.750 | 0.637 | 0.544 | 0.000 | 0.456 | 0.087 |
| 13 | 1.570 | 0.253 | 0.000 | 0.747 | 0.665 | 0.588 | 0.000 | 0.412 | 0.176 |

TABLE 4

| | | | | | | | Lithium secondary | |
|---|---|---|---|---|---|---|---|---|
| | Lithium-containing composite oxide | | | | Cathode active material | | battery | |
| | | | | Logarithmic | | Specific | Discharge | Cycle |
| | | | | standard | | surface | capacity | retention |
| Ex. | D₀₀₃ [nm] | D₁₁₀ [nm] | I₀₂₀/I₀₀₃ | deviation | D₅₀ [μm] | area [m²/g] | [mAh/g] | rate [%] |
| 1 | 102.4 | 54.1 | 0.040 | 0.082 | 6.1 | 1.76 | 193.5 | 90.2 |
| 2 | 102.4 | 54.1 | 0.040 | 0.082 | 6.2 | 1.85 | 192.5 | 95.4 |
| 3 | 114.8 | 67.8 | 0.052 | 0.134 | 7.2 | 1.34 | 182.5 | 90.3 |
| 4 | 89.4 | 50.7 | 0.036 | 0.128 | 6.6 | 1.39 | 194.3 | 90.2 |
| 5 | 90.0 | 57.8 | 0.075 | 0.195 | 6.9 | 1.50 | 190.1 | 92.5 |
| 6 | 92.6 | 45.6 | 0.024 | 0.115 | 6.2 | 1.23 | 188.1 | 94.5 |
| 7 | 89.9 | 43.1 | 0.031 | 0.126 | 5.9 | 1.15 | 194.6 | 86.1 |
| 8 | 95.9 | 46.4 | 0.019 | 0.142 | 5.7 | 1.61 | 190.3 | 87.3 |
| 9 | 78.5 | 44.5 | 0.039 | 0.173 | 6.3 | 1.54 | 181.3 | 88.5 |
| 10 | 81.8 | 42.6 | 0.045 | 0.100 | 8.1 | 1.15 | 193.5 | 85.1 |
| 11 | 77.4 | 40.0 | 0.035 | 0.200 | 6.6 | 2.30 | 178.0 | 76.8 |
| 12 | 66.8 | 36.3 | 0.037 | 0.264 | 6.7 | 3.07 | 194.4 | 71.0 |
| 13 | 68.4 | 35.0 | 0.037 | 0.253 | 5.9 | 1.81 | 193.7 | 74.4 |

The lithium secondary batteries in which the lithium-containing composite oxides of Ex. 1 to 10 wherein in an X-ray diffraction pattern, the logarithmic standard deviation of the crystalline size distribution obtained from a peak of (003) plane assigned to a crystal structure with space group R-3m is at most 0.198 were used, were excellent in the cycle characteristics.

The lithium secondary batteries in which the lithium-containing composite oxides of Ex. 11 to 13 wherein in an X-ray diffraction pattern, the logarithmic standard deviation of the crystalline size distribution obtained from a peak of (003) plane assigned to a crystal structure with space group R-3m exceeds 0.198 were used, were poor in the cycle characteristics.

### INDUSTRIAL APPLICABILITY

By the lithium-containing composite oxide of the present invention, it is possible to obtain a lithium iron secondary battery excellent in the discharge capacity and the cycle characteristics.

The entire disclosure of Japanese Patent Application No. 2015-079040 filed on Apr. 8, 2015 including specification, claims, drawings and summary is incorporated herein by reference in its entirety.

What is claimed is:

1. A lithium-containing composite oxide, which is represented by aLi(Li_{1/3}Mn_{2/3})O₂.(1−a)LiNi_{α}Co_{β}Mn_{γ}O₂ (wherein 0<a<1, 0<α<1, 0≦β<1, 0<γ≦0.5, and α+β+γ=1), wherein in its X-ray diffraction pattern, a logarithmic standard deviation of a crystalline size distribution obtained from a peak of (003) plane assigned to a crystal structure with space group R-3m is at most 0.198.

2. The lithium-containing composite oxide according to claim 1, wherein in the formula, α>γ.

3. The lithium-containing composite oxide according to claim 1, wherein a ratio of a molar amount of Ni to a total molar amount (X) of Ni, Co and Mn (i.e. Ni/X) is from 0.15 to 0.55, a ratio of a molar amount of Co thereto (i.e. Co/X) is from 0 to 0.09, and the ratio of the molar amount of Mn thereto (i.e. Mn/X) is from 0.45 to 0.8.

4. The lithium-containing composite oxide according to claim 1, wherein in its X-ray diffraction pattern, an integrated intensity ratio (I₀₂₀/I₀₀₃) of an integral intensity (I₀₂₀) of a peak of (020) plane assigned to a crystal structure with space group C2/m to an integral intensity (I₀₀₃) of a peak of (003) plane assigned to a crystal structure with space group R-3m is from 0.02 to 0.3.

5. A process for producing a lithium-containing composite oxide, which comprises mixing a transition metals-containing compound essentially containing Ni and Mn and optionally containing Co with a lithium compound so that a ratio of the molar amount of Li to a total molar amount (X) of Ni, Co and Mn (i.e. Li/X) is higher by from 2 to 16% than a theoretical composition ratio and firing an obtained mixture at from 980 to 1,100° C., to produce a lithium-containing composite oxide represented by aLi(Li_{1/3}Mn_{2/3})O₂.(1−a)LiNi_{α}Co_{β}Mn_{γ}O₂ (wherein 0<a<1, 0<α<1, 0≦β<1, 0<γ≦0.5, and α+β+γ=1).

6. The process for producing a lithium-containing composite oxide according to claim 5, wherein the transition metals-containing compound is a hydroxide essentially containing Ni and Mn and optionally containing Co.

7. The process for producing a lithium-containing composite oxide according to claim 5, wherein the lithium compound is lithium carbonate.

8. A cathode active material comprising the lithium-containing composite oxide as defined in claim 1.

9. A cathode active material comprising a lithium-containing composite oxide obtained by the process for producing a lithium-containing composite oxide as defined in claim 5.

10. A positive electrode for a lithium ion secondary battery, which comprises the cathode active material as defined in claim 8, an electrically conductive material and a binder.

11. A positive electrode for a lithium ion secondary battery, which comprises the cathode active material as defined in claim 9, an electrically conductive material and a binder.

12. A lithium ion secondary battery, which comprises the positive electrode for a lithium ion secondary battery as defined in claim 9, a negative electrode and a non-aqueous electrolyte.

13. A lithium ion secondary battery, which comprises the positive electrode for a lithium ion secondary battery as defined in claim 10, a negative electrode and a non-aqueous electrolyte.
